(19) United States
(12) Patent Application Publication
(10) Pub. No.: US 2023/0039747 A1
(43) Pub. Date: Feb. 9, 2023

(54) SYSTEM FOR MEASURING DIMENSIONS OF FOOD PARTICLES AND ASSOCIATED METHOD

(71) Applicant: NEOVIA, SAINT-NOLFF (FR)

(72) Inventors: Mikaël MARZIN, MORÉAC (FR); Vincent SINCHOLLE, VANNES (FR); Valérie BLANC, REZÉ (FR)

(21) Appl. No.: 17/786,950

(22) PCT Filed: Dec. 17, 2020
(86) PCT No.: PCT/FR2020/052504

§ 371 Date: Jul. 22, 2022

(30) Foreign Application Priority Data
Dec. 19, 2019 (FR) FR1914949

(51) Int. Cl. G01N 15/02; G01N 15/14; G01N 21/85; G01N 21/89

(52) U.S. Cl. CPC G01N 15/0205; G01N 15/1475; G01N 21/85; G01N 21/8914

(57) ABSTRACT

The present invention relates to a pellet holding device for feeding, comprising an angle bracket, the angle bracket having two planar parts connected to one another in an integral manner and forming an elongate fold between the two parts, and to a system for holding the pellets, which is capable of immobilizing one or more pellets against each of the two parts in the fold, the planar parts being optically transparent.

### FIELD OF THE INVENTION

The present invention relates to food, and more particularly to the field of monitoring the manufacture of food particles. It relates in particular to a method and a device for measuring dimensions of pellets.

### STATE OF THE ART

The pellets for food, for example for animal food, are particles that comprise food materials, for example compacted and/or dehydrated. The pellets have the advantage of being less dusty than powder or flour. The volume of the pellets is of particular importance: if a pellet has a too high volume, an animal may have difficulty swallowing it. On the other hand, if the pellet has a too small volume, the animal may tend to ingest a smaller amount of food. Thus, during the production of pellets, there is a need to accurately monitor the three-dimensional size and/or the volume of the pellets.

A pellet can have a regular geometric shape, such as a cylinder or a sphere. Thus, the measurement of one or two characteristic lengths of the pellet allows calculating its total volume.

It is known to measure, using a caliper, the diameter and the length of each of the pellets of a sample of pellets. This operation is long and tedious: for example, it can take more than 15 minutes for an experienced controller to measure a sample of 50 pellets.

To this end, document FR3049374 B1 describes a method for measuring the size and volume of pellets by acquisition of a digital image of a sample of pellets, as well as a digital processing that allows determining the diameter and the length of each of the pellets. Each pellet is assimilated to a sphere or to a spheroid during the estimation of its volume.

However, the method described in patent FR3049374 B1 does not allow accurately determining the volume of pellets whose shape is complex, particularly different from a sphere or a spheroid.

Indeed, with reference to FIG. 1 and FIG. 2, the pellets 2 of the prior art can have complex shapes such as hearts or irregular shapes. With reference to FIG. 2, the pellet 2 has for example a dog bone shape. The three-dimensional size of this shape can be approximated by measuring the length L, width W and thickness t of the pellet. A measurement of the volume of such pellets is not possible or inaccurate using the known measuring methods.

### DISCLOSURE OF THE INVENTION

One aim of the invention is to propose a solution for measuring the volume of food particles, preferably pellets, having complex shapes with accuracy.

This aim is achieved within the framework of the present invention thanks to a device for holding pellets for food, comprising:
an angle iron comprising two planar portions linked together in a secured manner and forming an elongated fold between the two portions,
a system for holding the pellets, adapted to immobilize one or several pellets against each of the two portions in the fold, the planar portions being optically transparent.

The invention is advantageously completed by the following characteristics, taken individually or in any one of their technically possible combinations:
the pellet holding system comprises a planar wedge and means for fixing the wedge to the angle iron, the fixing means being arranged so as to leave a clearance between the wedge and at least one of the two planar portions when the wedge is fixed to the angle iron,
the wedge is made of an opaque material,
the wedge is made of a blue material,
the holding system is configured so that the wedge has a face opposite one of the portions when the wedge is fixed to the angle iron, and in which a material of the wedge forming the face has a Young's modulus of less than 1 GPa,
the holding system comprises a bracket of a shape complementary to that of the angle iron.

Another aspect of the invention is a system for measuring the three-dimensional size of pellets for food comprising:
a transparent planar carrier,
an imaging system adapted to image an object in contact with the carrier through said carrier,
at least one device in accordance with the invention, one of the planar portions of the angle iron covering the planar carrier.

Another aspect of the invention is a system for measuring the three-dimensional size of pellets for food, comprising:
a transparent planar carrier,
an imaging system adapted to image an object in contact with the carrier through said carrier,
at least one device configured to immobilize a plurality of pellets on the carrier, and according to a plurality of different positions for each of the pellets.

Advantageously, the measuring system comprises a scanner, the scanner comprising the imaging system and the transparent planar carrier.

Another aspect of the invention is a method for measuring the three-dimensional size of pellets for food, comprising the following steps:

a) acquiring a first digital image of the immobilized pellets opposite a planar carrier,

b) rotating each of the pellets by an angle comprised between 70° and 110°, then immobilizing the pellets at this angle opposite the carrier, c) acquiring a second digital image of the pellets following step b).

Advantageously, the step b) is implemented by immobilizing the pellets in at least one pellet holding device in accordance with the invention.

### DESCRIPTION OF THE FIGURES

Other characteristics, aims and advantages of the invention will emerge from the following description, which is purely illustrative and not limiting, and which should be read in relation to the appended drawings in which:

FIG. 1 illustrates pellets of the prior art with complex shapes,

FIG. 2 illustrates a pellet of the prior art with a bone shape,

FIG. 3 schematically illustrates a pellet holding device according to one embodiment of the invention,

FIG. 4 schematically illustrates a device for holding pellets according to one embodiment of the invention,

FIG. 5 schematically illustrates a device for holding pellets according to one embodiment of the invention comprising a bracket-shaped wedge,

FIG. 6 schematically illustrates a system for measuring the three-dimensional size of pellets according to one embodiment of the invention,

FIG. 7 schematically illustrates a method for measuring the three-dimensional size of pellets according to one embodiment of the invention,

FIG. 8 is a photograph of pellets acquired by a measuring system in accordance with the invention,

FIG. 9 is a photograph of pellets acquired by a measuring system in accordance with the invention.

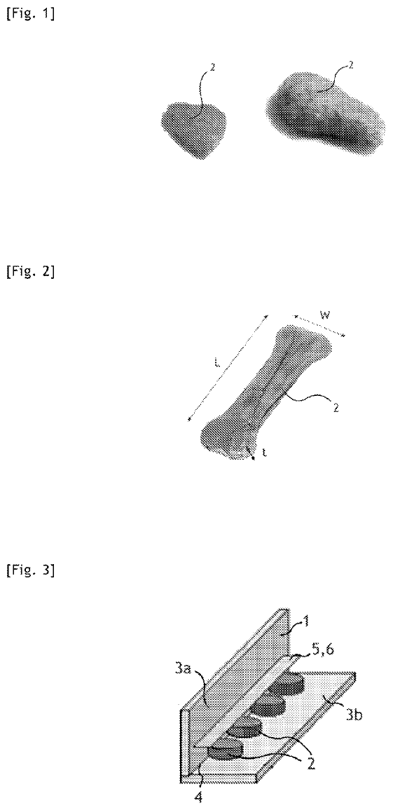

In all the figures, similar elements bear identical references.

### DETAILED DESCRIPTION OF THE INVENTION

Device 1 for Holding the Pellets

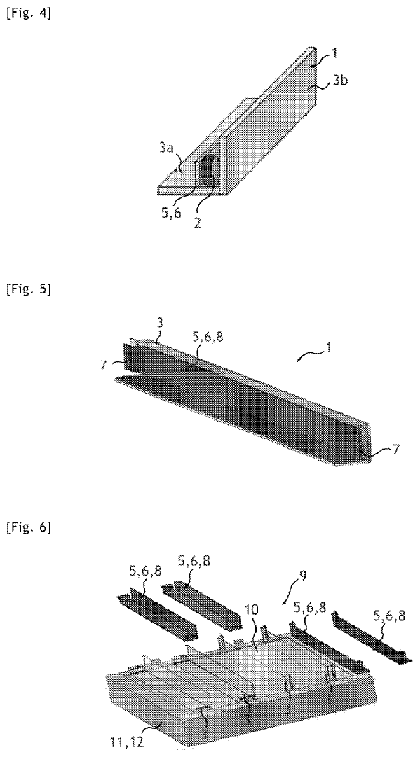

With reference to FIG. 3 and FIG. 4, a device 1 for holding pellets 2 for food in accordance with the invention comprises an angle iron 3, the angle iron 3 comprising two planar portions 3a, 3b. The two planar portions 3a, 3b are linked together in a secured manner, forming an elongated fold 4 between the two portions 3a, 3b. The fold 4 can be the interior of the vertex of a 90° angle formed between the portion 3a and the other portion 3b.

The device 1 also comprises a system 5 for holding the pellets 2, adapted to immobilize one or several pellets 2 against each of the two portions 3a, 3b, in the fold 4. Thus, it is possible to dispose along the angle iron 3 pellets 2, separated from each other, and immobilized in the angle iron 3. By “immobilized”, it is meant that the pellets 2 are stable in a given position. The pellets can for example be immobilized by gravity by resting against one of the portions 3a, 3b of the angle iron 3 or both.

The planar portions 3a, 3b are at least partly, and preferably entirely, optically transparent. By “transparent”, it is meant that it is possible to discern an object immobilized in the angle iron 3 from the exterior of the angle iron 3. More particularly, it is meant that the angle iron 3, by virtue of its material and its geometry, absorbs less 50% of the energy of light waves in the visible range, preferably without changing the wavelength. Thus, for a fixed observer, for example a fixed imaging system, it is possible to observe all of the pellets 2 immobilized in the device 1 at two different angles, depending on whether the device 1 rests on a portion 3a or on the other portion 3b. The angle iron 3 can for example be made of transparent plastic, such as [ . . . ]. FIG. 3 illustrates a device 1 resting on the portion 3b, and FIG. 4 illustrates the same device 1 resting on the portion 3a.

The system 5 for holding the pellets 2 can preferably comprise a planar wedge 6, and means 7 for fixing the wedge 6 to the angle iron 3.

With reference to FIG. 5, the fixing means 7 are arranged so as to leave a clearance between the wedge 6 and at least one of the two planar portions 3a, 3b when the wedge 6 is fixed to the angle iron 3. The clearance between the wedge 6 and the angle iron 3 has a length less than one centimeter, and preferably less than 5 mm. Thus, it is possible to immobilize the pellets 2 along the angle iron 3 by exerting pressure on each of the pellets when the wedge 6 is fixed to the angle iron 3. The fixing means 7 can comprise screw and nut systems, the wedge 6 and/or the angle iron 3 having cutouts adapted to said fixing by the screws and the nuts. The fixing means 7 can alternatively comprise clips, or any other removable fixing means.

The wedge 6, and more generally the holding system 5 can be made of an opaque material. By opaque, it is meant that the material absorbs more than 90% of the transmitted light energy. Thus, the wedge 6 and/or the holding system 5 form an opaque background during the imaging of the pellets 2 through one of the transparent portions 3a, 3b of the angle iron 3.

The wedge 6 is preferably made of a blue material. By blue, it is meant blue according to the AFNOR X08-010 standard, i.e. emitting or reflecting light waves with a wavelength comprised between 466 nm and 490 nm. Thus, it is possible, during the imaging of the pellets 2, to facilitate the recognition of the contours of the pellets 2 by a computer processing. Indeed, the inventors measured that the color furthest chromatically from the pellets, on average, was blue.

The holding system 5 can be configured so that, when fixing the wedge 6 to the angle iron 3, the wedge 6 has a face opposite one of the portions 3a, 3b, and so that the material forming this face has a Young's modulus of less than 1 GPa, and preferably less than 10 MPa. Thus, as the pellets 2 are fragile with regard to the pressure, the face of the wedge 6 can deform on contact with the pellets 2, and avoid degrading the pellets 2 when fixing the wedge 6.

The holding system 5 can also comprise a bracket 8, the shape of the bracket 8 being complementary to that of the angle iron 3. A planar portion of the bracket 8 then forms the wedge 6. The other portion of the bracket can serve as an opaque background during the imaging of the pellets 2 immobilized in the device 1. Particularly, the bracket 8 can be fixed to the angle iron 3 according to two configurations. In a first configuration, the bracket 8 is fixed to the angle iron 3 so that one of the faces of the bracket 8 is a wedge 6 for the holding system 5.

Measuring System 9

With reference to FIG. 6, another aspect of the invention is a system 9 for measuring the three-dimensional size of pellets for food. The measuring system 9 comprises a transparent planar carrier 10, intended to support the holding device 1 in accordance with the invention. The measuring system 9 also comprises at least one device 1 in accordance with the invention, arranged on the transparent planar carrier 10, on one of its portions 3a or 3b.

In general, the measuring system 9 can comprise, instead of the device 1, a device configured to immobilize a plurality of pellets 2 on the carrier 10 and according to a plurality of different positions for each of the pellets 2. Finally, the measuring system 9 comprises an imaging system 11 adapted to image an object in contact with the carrier 10, and preferably through the carrier 10.

The imaging system 11 can be preferably disposed on the opposite side to the object to be imaged, relative to the carrier 10. Thus, it is possible to image all of the pellets 2 from different angles, by changing the portion 3a or 3b on which the device 1 rests on the carrier 10. Alternatively, the imaging system and the object to be imaged can be disposed on the same side of the carrier 10.

The measuring system 9 is preferably a portable system. It is meant by “Portable” a system that can be hand-carried by a user. The measuring system 9 preferably comprises an enclosure, for example in the form of a suitcase, the enclosure comprising the carrier 10, the imaging system 11 and the pellet 2 holding device 1. The enclosure preferably has matt and dark, preferably black, internal faces, so as to avoid imaging reflections during the measurement of the three-dimensional size of the pellets 2.

The measuring system 9 preferably comprises a scanner, the scanner comprising both the imaging system 11 and the transparent planar carrier 10. By “scanner” it is meant a device comprising a transparent planar carrier 10, and a linear image sensor, for example of the CCD or CIS type, disposed under the planar carrier 10, and motorized so as to scan the surface of a portion of the carrier 10, making it possible to image an object disposed on the other side of the carrier 10.

Method for Measuring the Three-Dimensional Size of the Pellets 2

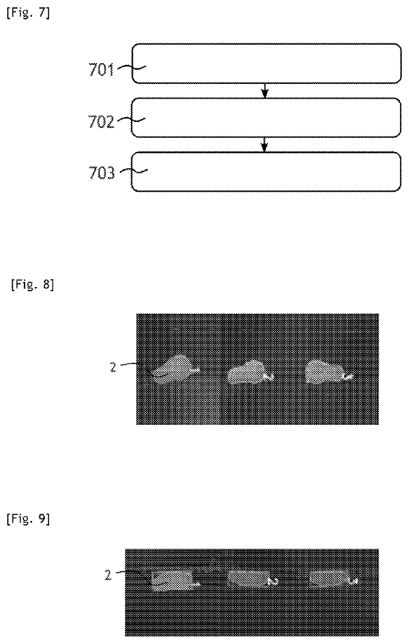

With reference to FIG. 7, another aspect of the invention is a method for measuring the three-dimensional size of pellets 2 for food. The method comprises a first step 701 of acquiring a first digital image of the pellets 2 immobilized opposite the planar carrier. It is for example possible to image between 10 and 200 pellets, preferably between 50 and 100 pellets 2. The method comprises a second subsequent step 702 of rotating each of the pellets 2 by an angle comprised between 70° and 110°, then of immobilizing the pellets 2 at this angle opposite the carrier 10. Preferably, the rotation of each of the pellets can be implemented along an axis of rotation different from an axis perpendicular to the carrier 10. In particular, the rotation of each of the pellets can be implemented along an axis of rotation parallel to the carrier. The method comprises a subsequent third step 703 of acquiring a digital image of the pellets 2. Thus, it is possible to obtain, using the two acquired digital images, information in the three dimensions of space on the size of each of the pellets 2 of the sample. The method preferably comprises a step subsequent to the third step 703 of calculating and/or approximating three different dimensions of each pellet 2 from the first digital image and from the second digital image. For example, the length L, the width W and the height h of each pellet 2 can be calculated.

Preferably, the second step 702 is implemented by immobilizing the pellets 2 in at least one device 1 in accordance with the invention.

The pellets 2 can be deposited on the angle iron 3. The first step 701 can be implemented by acquiring a first digital image of the pellets 2 thus deposited. Preferably, the bracket 8 can be fixed to the angle iron 3 during the first step 701, in a configuration in which the wedge 6 is not in contact with the pellets 2 and in which another portion of the bracket 8 is a matt background during the acquisition of the first digital image of the pellets 2. FIG. 8 illustrates one example of a first digital image in which three pellets are photographed.

The second step 702 can be implemented by bringing the wedge 6 closer so as to raise the pellets in the fold 6, and thus cause a rotation of each of the pellets 2 by an angle approximately equal to 90°. The pellets 2 are thus immobilized at this angle by fixing the wedge 6 of the bracket 8 to the angle iron 3. Finally, during a third step 703, a second digital image of the pellets 2 which are still held by the wedge 6 is acquired. FIG. 9 illustrates one example of a second digital image of the same three pellets 2 illustrated in FIG. 8. Thus, it is possible, during computer post-processing, to reconstitute at least three different dimensions of each of the pellets 2 from the first digital image and the second digital image. Furthermore, the use of the pellet 2 holding device 1 in the method allows parallelizing and monitoring accurately the rotation of each of the pellets 2.

1. A device for holding pellets for food, the device comprising:
an angle iron comprising two planar portions linked together in a secured manner and forming an elongated fold between the two portions, the planar portions being optically transparent, and
a pellet holding system configured to immobilize one or several of the pellets against each of the two portions in the fold,
the pellet holding system comprising a planar wedge and fixing means for fixing the wedge to the angle iron,
the fixing means being configured to leave a clearance between the wedge and at least one of the two planar portions when the wedge is fixed to the angle iron.

2. The device according to claim 1, wherein the wedge is made of an opaque material.

3. The device according to claim 1, wherein the holding system is configured so that the wedge has a face opposite one of the portions when the wedge is fixed to the angle iron, and wherein a material of the wedge forming the face has a Young's modulus of less than 1 GPa.

4. The device according to claim 1, wherein the holding system comprises a bracket of a shape complementary to a shape of the angle iron.

5. A system for measuring a three-dimensional size of pellets for food,
the system comprising:
a transparent planar carrier,
an imaging system configured to image an object in contact with the carrier through the carrier, and
at least one device in accordance with claim 1, one of the planar portions of the angle iron covering the planar carrier.

6. The measuring system according to claim 6, comprising a scanner, the scanner comprising the imaging system and the transparent planar carrier.

7. A method for measuring a three-dimensional size of pellets for food,
the method comprising the following steps:
a) acquiring a first digital image of immobilized pellets opposite a planar carrier,
b) rotating each of the pellets by an angle comprised between 70° and 110°, then immobilizing the pellets at this angle opposite the carrier, and
c) acquiring a second digital image of the pellets following step b), so as to obtain, using the two digital images acquired during steps a) and c), information in the three dimensions of space on the size of each of the pellets.

8. The method according to claim 8, wherein step b) is implemented by immobilizing the pellets in at least one device according to claim 1.

9. The device according to claim 1, wherein the wedge is made of a blue material.
